(19) United States
(12) Patent Application Publication
(10) Pub. No.: US 2017/0356242 A1
(43) Pub. Date: Dec. 14, 2017

(54) BLIND ASSEMBLY AND A WINDING DEVICE THEREOF

(71) Applicant: Ke-Min LIN, Chiayi City (TW)

(72) Inventor: Ke-Min LIN, Chiayi City (TW)

(21) Appl. No.: 15/182,134

(22) Filed: Jun. 14, 2016

(51) Int. Cl. E06B 9/56; E06B 9/44; E06B 9/60

(52) U.S. Cl. CPC E06B 9/56; E06B 9/60; E06B 9/44

(57) ABSTRACT

A blind assembly includes first and second side seats, a rotatable winding shaft, a shade member wound on the winding shaft, and a winding device. The winding device has a fixing unit, a coupling barrel, and a scroll spring. The fixing unit has a fixing portion disposed non-rotatably on the first side seat, and a spring-mounting portion extending oppositely to the fixing portion. The coupling barrel is disposed in and co-rotatable with the winding shaft, and is rotatable relative to the fixing unit. The scroll spring has opposite ends disposed respectively on the spring-mounting portion and the coupling barrel, such that rotation of the coupling barrel generates a resilient force for retracting the shade member.

### FIELD

The disclosure relates to a blind assembly and a winding device thereof.

### BACKGROUND

A conventional blind usually has a cord operable to pull up or down a shade thereof. The cord may dangerously entangle with a child who plays with it, so cordless blinds have been provided in recent years. Referring to FIGS. 1 and 2, U.S. Pat. No. 8,251,120B2 discloses a conventional cordless blind 1, which includes first and second seats 11, 12 spaced apart from each other, a winding device 13 mounted on an inner side of the first seat 11, a shaft 14 rotatably disposed between the second seat 12 and the winding device 13, and a shade 15 wound on the shaft 14.

The first seat 11 has two spaced-apart posts 111, 112. The winding device 13 has a cover 131 disposed at the inner side of the first seat 11, a roller 133 rotatably disposed on the post 112, a linking member 134 interconnecting the roller 133 and the shaft 14, and an S-shaped spring 132 having an end that is connected fixedly to the post 111 and an opposite end that is connected fixedly to the roller 133, such that rotation of the roller 133 twists the S-shaped spring 132. Since a resilient force of the S-shaped spring 132 when being twisted is equal to the weight of an unwound portion of the shade 15, the shade 15 can be pulled up or down cordlessly to any desired extent.

The conventional cordless blind 1 enables the shade 15 to maintain at the desired extent and improves safety of use. However, referring to FIG. 3, when the conventional cordless blind 1 is adapted to be mounted between two window sides 101 of a window 10, since the winding device 13 is disposed outside of the shaft 14 (i.e., the shaft 14 is between the winding device 13 and the second seat 12), a side of the shade 15 which is adjacent to the winding device 13 cannot be close to a respective one of the window sides 101 which is connected to the first seat 11, thereby causing a relatively large light leakage gap therebetween that would affect the light-shading function of the conventional cordless blind 1.

### SUMMARY

Therefore, an object of the disclosure is to provide a blind assembly that can reduce the light leakage gap associated with the abovementioned prior art.

Accordingly, the blind assembly includes first and second side seats spaced apart from each other, a winding shaft, a shade member, and a winding device. The winding shaft has an end mounted rotatably to the second side seat, and that is formed with an internal passage. The shade member is wound on the winding shaft. The winding device has a fixing unit, a coupling barrel, and a scroll spring. The fixing unit has a fixing portion that is non-rotatably disposed on the first side seat, and a spring-mounting portion that extends in a direction opposite to the fixing portion. The coupling barrel is disposed in the internal passage, is co-rotatable with the winding shaft, is rotatable relative to the fixing unit, and has a barrel wall that defines a receiving space receiving the spring-mounting portion. The scroll spring is disposed in the coupling barrel, and has a fixing end disposed on the spring-mounting portion, and a connecting end disposed on the barrel wall of the coupling barrel, such that rotation of the coupling barrel relative to the fixing unit generates a resilient force of the scroll spring for retracting the shade member.

Another object of the disclosure is to provide a winding device that can be connected to a blind assembly.

Accordingly, the winding device is adapted to be connected to a blind assembly for disposing a winding shaft on a first side seat. The winding shaft is formed with an internal passage. The winding device includes a fixing unit, a coupling barrel, and a scroll spring. The fixing unit has a fixing portion adapted to be non-rotatably disposed on the first side seat, and a spring-mounting portion extending in a direction opposite to the fixing portion. The coupling barrel is adapted to be disposed in the internal passage and co-rotatable with the winding shaft. The coupling barrel is rotatable relative to the fixing unit, and has a barrel wall that defines a receiving space receiving the spring-mounting portion. The scroll spring is disposed in the coupling barrel. The scroll spring has a fixing end disposed on the spring-mounting portion, and a connecting end disposed on the barrel wall, such that rotation of the coupling barrel relative to the fixing unit generates a resilient force of the scroll spring that is adapted for retracting a shade member.

### BRIEF DESCRIPTION OF THE DRAWINGS

Other features and advantages of the disclosure will become apparent in the following detailed description of the embodiment with reference to the accompanying drawings, of which:

FIG. 1 is a partly exploded perspective view of a conventional cordless blind disclosed in U.S. Pat. No. 8,251,120B2;

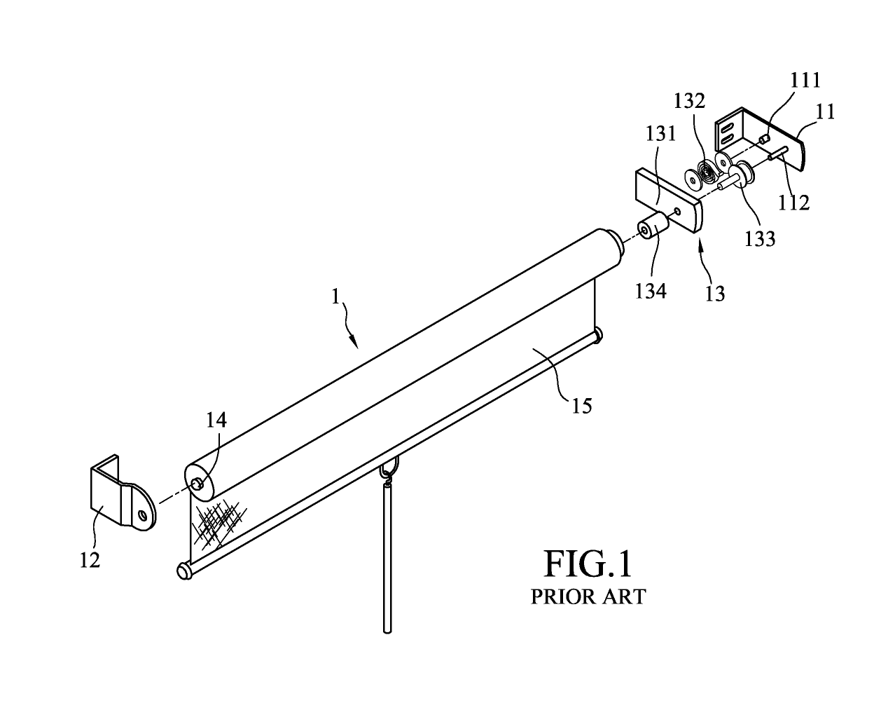

FIG. 2 is a schematic sectional view illustrating a winding device of the conventional cordless blind disclosed in U.S. Pat. No. 8,251,120B2;

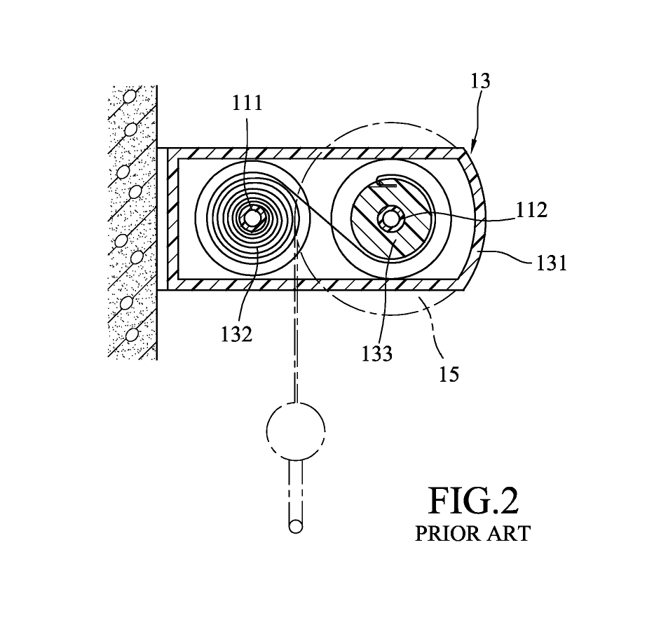

FIG. 3 is a front view of the conventional cordless blind disclosed in U.S. Pat. No. 8,251,120B2 which is mounted between two window sides of a window;

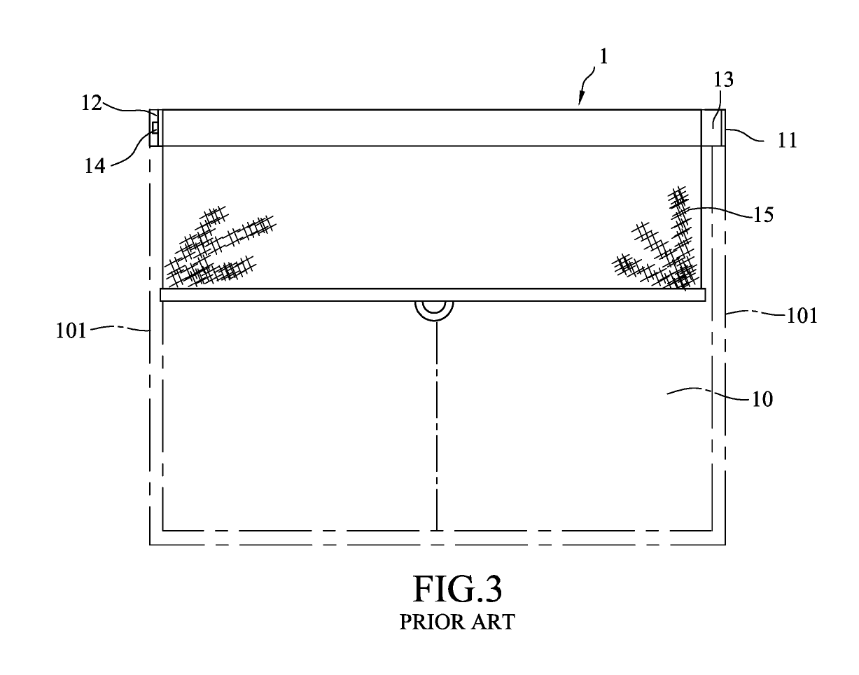

FIG. 4 is a partly sectional view illustrating a first embodiment of a winding device according to the disclosure mounted to a blind assembly;

FIG. 5 is an exploded perspective view of the first embodiment;

FIG. 6 is an exploded sectional view of the first embodiment;

FIG. 7 is a sectional side view of the first embodiment;

FIG. 8 is a sectional front view of the first embodiment; and

FIG. 9 is a sectional front view of a second embodiment of the winding device according to the disclosure.

### DETAILED DESCRIPTION

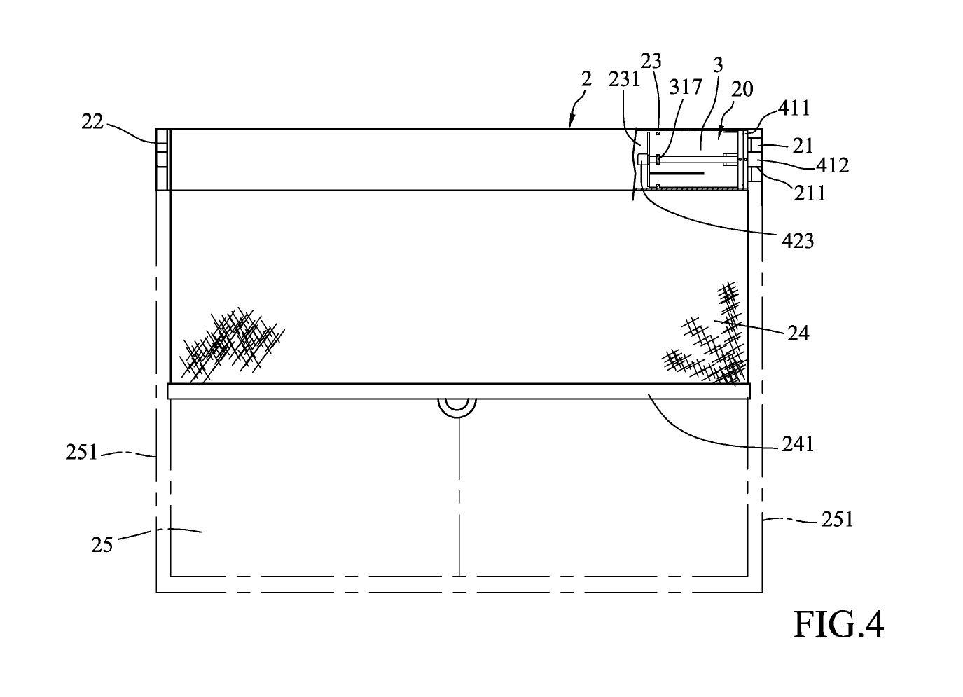

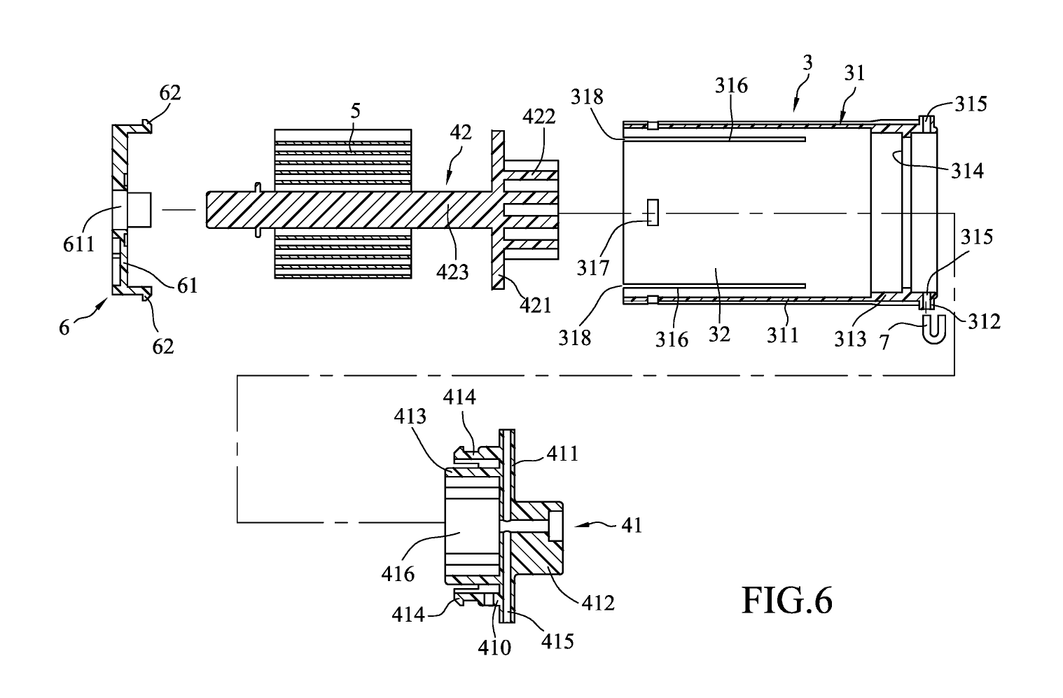

Referring to FIGS. 4, 5 and 6, a blind assembly 2 is illustrated to include a first embodiment of a winding device 20 according to the present disclosure, and to be mounted between two opposite sides 251 of a window structure 25. The blind assembly 2 further includes first and second side seats 21, 22 spaced apart from each other, a rotatable winding shaft 23, and a shade member 24. The first side seat 21 has anon-circular positioning hole 211. The winding device 20 connects an end of the winding shaft 23 to the first side seat 21. The winding shaft 23 has an opposite end mounted rotatably to the second side seat 22, and that is formed with an internal passage 231. The shade member 24 is wound on the winding shaft 23, and has a counterweight portion 241 being adjacent to a bottom end thereof.

The winding device 20 has a coupling barrel 3, a fixing unit 4, a scroll spring 5, an end cover 6, and a pin 7.

The coupling barrel 3 is disposed in the internal passage 231, and is co-rotatable with the winding shaft 23. In this embodiment, the coupling barrel 3 has a barrel wall 31 defining a receiving space 32. The barrel wall 31 has a hollow main portion 311, an annular outer portion 312 extending outwardly from the main portion 311 and being proximate to the first side seat 21, two first pin holes 315 angularly spaced apart from each other and extending through the main portion 311 and the outer portion 312, two first spring grooves 316 formed in the main portion 311 and angularly spaced apart from each other, and four hook grooves 317 formed in the main portion 311 and being distal from the outer portion 312. The barrel wall 31 further has an annular inner portion 313 extending inwardly from the main portion 311, and that has a shoulder part 314 projecting inwardly into the receiving space 32. Each of the spring grooves 316 has an entrance 318 that is formed at an end of the main portion 311 which is opposite to the outer portion 312.

In this embodiment, the fixing unit 4 includes a fixing seat 41, and a spring-mounting seat 42 coupled fixedly to the fixing seat 41. The fixing seat 41 has a base plate portion 411 disposed outside of and abutting against the barrel wall 31 of the coupling barrel 3, a fixing portion 412 extending from the base plate portion 411 and fittingly and non-rotatably engaging the positioning hole 211 of the first side seat 21, a projecting portion 413 extending from the base plate portion 411 into the receiving space 32 of the coupling barrel 3, a collar portion 410 extending from the base plate portion 411 toward the receiving space 32 and surrounding the projecting portion 413, and four hook portions 414 extending from the collar portion 410, surrounding the projecting portion 413, and hooking the shoulder part 314 of the inner portion 313 of the barrel wall 31 of the coupling barrel 3, such that the barrel 31 is rotatable relative to the fixing unit 4. The base plate portion 411 has a second pin hole 415. The pin 7 is U-shaped. The projecting portion 413 of the fixing seat 41 has an engaging hole 416.

The spring-mounting seat 42 has an abutting portion 421 abutting against the projecting portion 413 of the fixing seat 41, an engaging portion 422 extending from the abutting portion 421 and engaging fixedly the engaging hole 416 of the fixing seat 41, and a spring-mounting portion 423 extending from the abutting portion 421 in a direction opposite to the fixing portion 412 of the fixing seat 41, and received in the receiving space 32 of the coupling barrel 3. In this embodiment, the spring-mounting portion 423 has two second spring grooves 424, but the spring-mounting portion 423 may have only one second spring groove 424 in other embodiments.

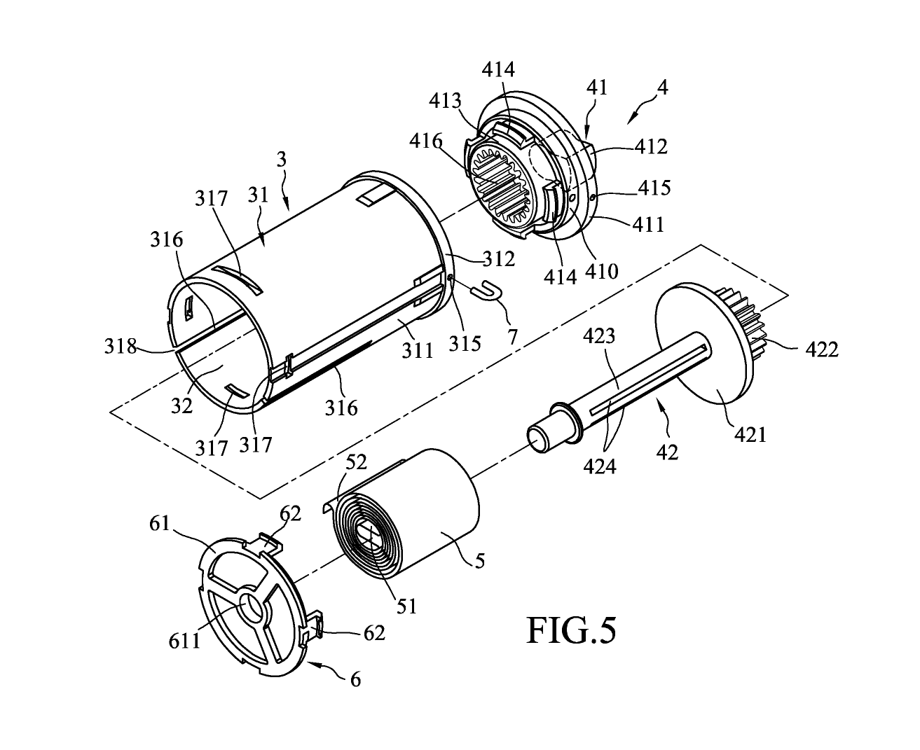

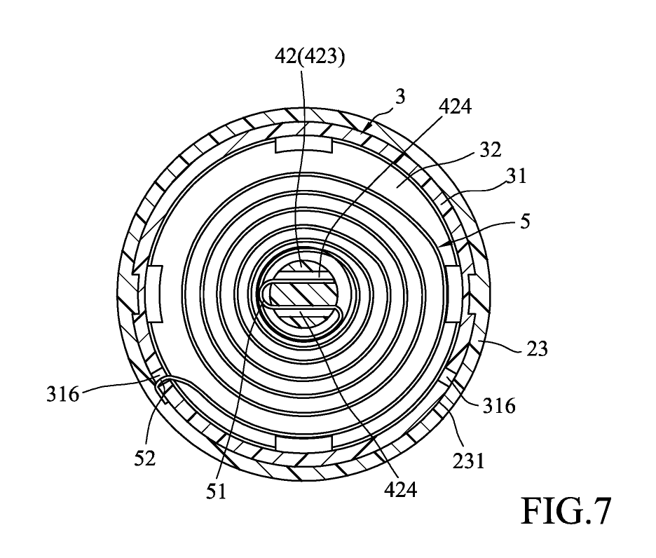

Referring to FIGS. 5, 6 and 7, the scroll spring 5 is disposed in the coupling barrel 3, and has a fixing end 51 disposed on the spring-mounting portion 423 by engaging one of the second spring grooves 424 of the spring-mounting seat 42, and a connecting end 52 disposed on the barrel wall 31 of the coupling barrel 3 by engaging one of the first spring grooves 316. As such, rotation of the coupling barrel 3 relative to the fixing unit 4 twists the scroll spring 5 to generate a resilient force for retracting the shade member 24. The counterweight portion 241 pulls the shade member 24 downwardly against the resilient force of the scroll spring 4, thereby maintaining the shade member 24 at any desired state. Since the application of the interaction between the resilient force of the scroll spring 5 and the weight of the shade member 24 is known in the art, further details on the same are omitted herein for the sake of brevity.

The end cover 6 has a circular end wall 61, and four cover hooks 62 extending from the end cover 61 and respectively engaging the hook grooves 317 of the coupling barrel 3 such that the end cover 6 is co-rotatable with the barrel wall 31. The end wall 61 of the end cover 6 has a connecting hole 611 engaged rotatably with the spring-mounting portion 423 of the spring-mounting seat 42.

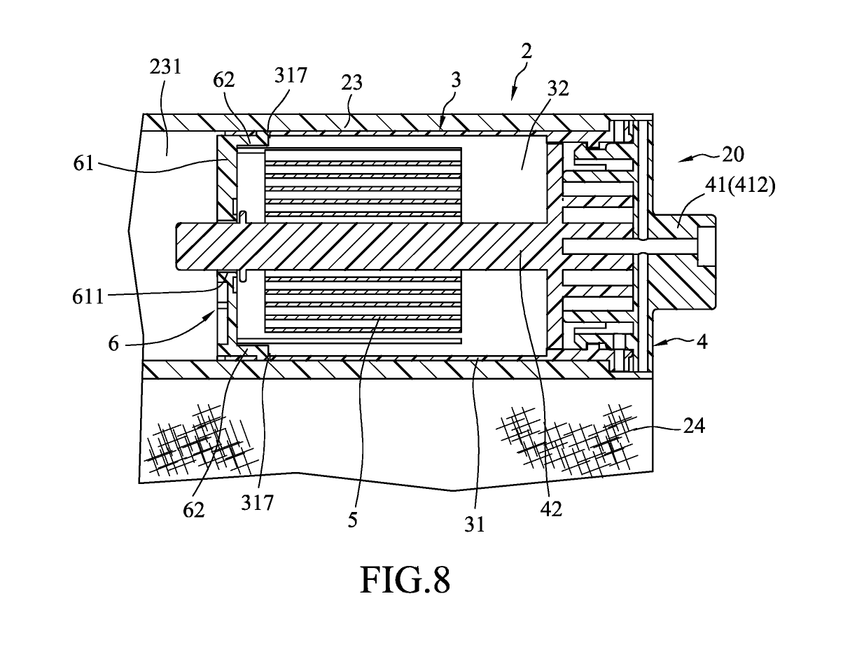

Referring to FIGS. 5, 7 and 8, when assembling the winding device 20 of this embodiment, a user needs to couple the fixing seat 41 to the coupling barrel 3, engage the fixing end 51 of the scroll spring 5 with one of the second spring grooves 424 of the spring-mounting seat 42, then install the spring-mounting seat 42 and the scroll spring 5 into the receiving space 32 of the coupling barrel 3, and finally engage the connecting end 52 of the scroll spring 5 with one of the first spring grooves 316 through the entrance 318 thereof. Before the engaging portion 422 of the spring-mounting seat 42 engages the engaging hole 416 of the fixing seat 41, the spring-mounting seat 42 is rotated relative to the barrel wall 31 for generating the resilient force of the scroll spring 5. Afterward, the user pushes the spring-mounting seat 42 toward the fixing seat 41, and fixes the spring-mounting seat 42 to the fixing seat 41. At this time, the second pin hole 415 is registered with one of the first pin holes 315, and the user can insert the pin 7 into the one of the first pin holes 315 and the second pin hole 415 for locking the fixing unit 4 to the coupling barrel 3, thereby maintaining the resilient force.

Referring to FIGS. 4, 7 and 8, after the winding device 20 is installed into the internal passage 231 of the winding shaft 23 of the blind assembly 2, the pin 7 is removed from the one of the first pin holes 315 and and the second pin hole 415, so that the coupling barrel 3 is rotatable relative to the fixing unit 4 and the blind assembly 2 is ready for use.

Specifically, when the winding device 20 is mounted on the blind assembly 2, the fixing portion 412 of the fixing seat 41 extends out of the internal passage 231 of the winding shaft 23. The remainder of the winding device 20, which is a significant portion of the winding device 20, is received inside the internal passage 231, so that one lateral side of the shade member 24 which is proximate to the winding device 20 would be relatively close to a corresponding one of the window sides 251 of the window 25, that is, a light leakage gap that would be formed between the shade member 24 and the respective one of the window sides 251 can be reduced.

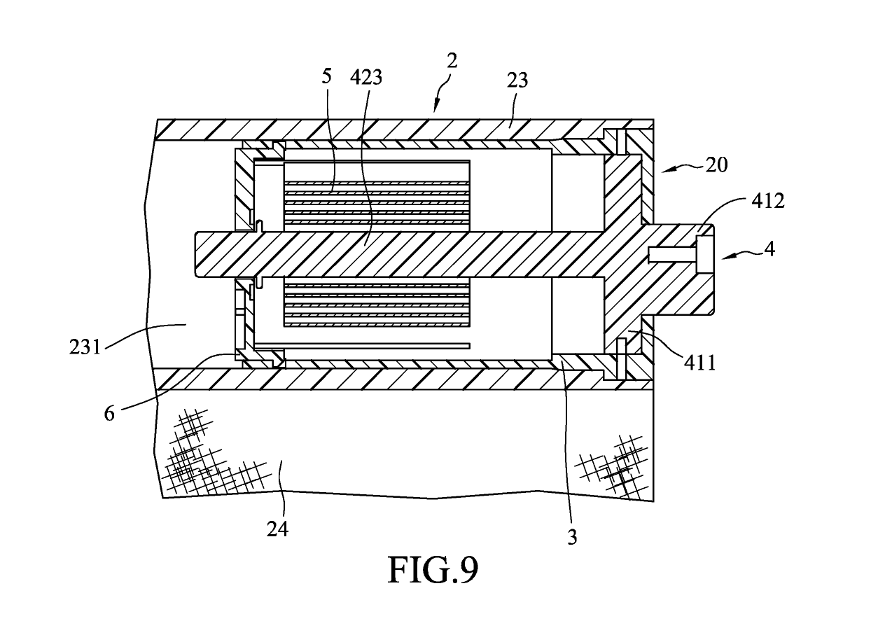

Referring to FIG. 9, a second embodiment of the blind assembly 2 according to the present disclosure has a structure similar to that of the first embodiment, except that the fixing seat 41 and the spring-mounting seat 42 are molded as one piece with the engaging hole 416 and the engaging portion 422 disclosed in the first embodiment being omitted.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that his disclosure is not limited to the disclosed embodiment but is intended to cover various arrangements included within the spirit and scope of the broadest interpretation so as to encompass all such modifications and equivalent arrangements.

What is claimed is:

1. A blind assembly comprising:
a first side seat;
a second side seat that is spaced apart from said first side seat;
a winding shaft that has an end mounted rotatably to said second side seat, and that is formed with an internal passage;
a shade member that is wound on said winding shaft; and
a winding device that has
a fixing unit having
a fixing portion that is non-rotatably disposed on said first side seat, and
a spring-mounting portion that extends in a direction opposite to said fixing portion;
a coupling barrel disposed in said internal passage, co-rotatable with said winding shaft, rotatable relative to said fixing unit, and having a barrel wall that defines a receiving space receiving said spring-mounting portion; and
a scroll spring disposed in said coupling barrel and having
a fixing end that is disposed on said spring-mounting portion, and
a connecting end that is disposed on said barrel wall of said coupling barrel, such that rotation of said coupling barrel relative to said fixing unit generates a resilient force of said scroll spring for retracting said shade member.

2. The blind assembly as claimed in claim 1, wherein:
said barrel wall of said coupling barrel of said winding device has at least one first pin hole;
said fixing unit further has a second pin hole being registered with said at least one first pin hole when said coupling barrel is rotated relative to said fixing unit until the resilient force of said scroll spring is generated; and
said winding device further has a pin being insertable into one of said at least one first pin hole and said second pin hole upon registration of said at least one first pin hole with said second pin hole and generation of the resilient force, thereby maintaining the resilient force.

3. The blind assembly as claimed in claim 2, wherein:
said barrel wall of said coupling barrel further has at least one first spring groove engaged with said connecting end of said scroll spring; and
said spring-mounting portion of said fixing unit has at least one second spring groove engaged with said fixing end of said scroll spring.

4. The blind assembly as claimed in claim 1, wherein said winding device further has an end cover coupled co-rotatably to said barrel wall of said coupling barrel, and having a connecting hole that is engaged rotatably with said spring-mounting portion of said fixing unit.

5. A winding device adapted to be connected to a blind assembly for disposing a winding shaft on a first side seat, the winding shaft being formed with an internal passage, said winding device comprising:
a fixing unit having
a fixing portion that is adapted to be non-rotatably disposed on the first side seat, and
a spring-mounting portion that extends in a direction opposite to said fixing portion;
a coupling barrel being adapted to be disposed in the internal passage and co-rotatable with the winding shaft, being rotatable relative to said fixing unit, and having a barrel wall that defines a receiving space receiving said spring-mounting portion; and
a scroll spring disposed in said coupling barrel, and having
a fixing end that is disposed on said spring-mounting portion, and
a connecting end that is disposed on said barrel wall of said coupling barrel, such that rotation of said coupling barrel relative to said fixing unit generates a resilient force of said scroll spring adapted for retracting a shade member.

6. The winding device as claimed in claim 5, wherein:
said barrel wall of said coupling barrel has at least one first pin hole;
said fixing unit further has a second pin hole being registered with said at least one first pin hole when said coupling barrel is rotated relative to said fixing unit until the resilient force of said scroll spring is generated; and
said winding device further has a pin being insertable into one of said at least one first pin hole and said second pin hole upon registration of said at least one first pin hole with said second pin hole and generation of the resilient force, thereby maintaining the resilient force.

7. The winding device as claimed in claim 5, wherein said fixing unit includes a fixing seat having said fixing portion, and a spring-mounting seat having said spring-mounting portion and coupled fixedly to said fixing seat.

8. The winding device as claimed in claim 7, wherein:
said barrel wall of said coupling barrel has a shoulder part projecting inwardly into said receiving space;
said fixing seat further has a projecting portion extending into said receiving space, and a plurality of hook portions surrounding said projecting portion and hooking said shoulder part of said barrel wall;
said projecting portion of said fixing seat has an engaging hole; and
said spring-mounting seat further has an engaging portion engaging fixedly said engaging hole.

9. The winding device as claimed in claim 5, wherein:
said barrel wall of said coupling wall further has a first spring groove engaged with said connecting end of said scroll spring; and
said spring-mounting portion of said fixing unit has a second spring groove engaged with said fixing end of said scroll spring.

10. The winding device as claimed in claim 5, further comprising an end cover that is coupled co-rotatably to said barrel wall of said coupling barrel, and that has a connecting hole that is engaged rotatably with said spring-mounting portion of said fixing unit.
